(19) United States
(12) Patent Application Publication
(10) Pub. No.: US 2022/0073103 A1
(43) Pub. Date: Mar. 10, 2022

(54) METACOGNITION-BASED AUTONOMOUS DRIVING CORRECTION DEVICE AND METHOD

(71) Applicant: Electronics and Telecommunications Research Institute, Daejeon (KR)

(72) Inventor: Kyoung Hwan AN, Daejeon (KR)

(73) Assignee: Electronics and Telecommunications Research Institute, Daejeon (KR)

(21) Appl. No.: 17/469,276

(22) Filed: Sep. 8, 2021

(30) Foreign Application Priority Data
Sep. 8, 2020 (KR) 10-2020-0114968

(51) Int. Cl. B60W 60/00; B60W 40/09; B60W 30/182; B60W 30/18; G06K 9/00; G01C 21/34; H04W 4/46

(52) U.S. Cl. CPC B60W 60/0015; B60W 40/09; B60W 30/182; B60W 30/18154; G06K 9/00791; G01C 21/3415; G06K 2209/21; B60W 2554/80; B60W 2556/65; B60W 2556/55; G06K 2209/23; G06K 2209/15; H04W 4/46

(57) ABSTRACT

The present invention relates to a metacognition-based autonomous driving correction device for an autonomous driving system. The autonomous driving correction device includes a driving situation recognition/driving behavior-based determination unit which determines metacognition with respect to a front object recognized during autonomous driving using driving environment recognition information acquired through a vehicle sensor unit and corrects a global route or a local route so as to correspond to selection correction information selected after metacognition is determined, and a driving situation recognition/driving behavior correction terminal unit which outputs pieces of candidate correction information when a driving situation of the front object is determined to correspond to metacognition and then provides the selection correction information selected from among the pieces of output candidate correction information by a driver to the driving situation recognition/driving behavior-based determination unit.

### CROSS-REFERENCE TO RELATED APPLICATION

This application claims priority to and the benefit of Korean Patent Application No. 10-2020-0114968, filed on Sep. 8, 2020, the disclosure of which is incorporated herein by reference in its entirety.

### BACKGROUND

### 1. Field of the Invention

The present invention relates to a metacognition-based autonomous driving correction device and, more particularly, to driving correction in a metacognitive state in an autonomous driving system.

### 2. Discussion of Related Art

Conventional autonomous driving systems determine all driving situations and actions according to a preset algorithm. When the autonomous driving system reaches a limit where driving is no longer possible, the autonomous driving system transfers control authority to a driver according to an autonomous driving level to release an autonomous driving mode or take an action such as a smooth stop or a pulling onto the shoulder.

However, even in a normal driving situation, the autonomous driving system may not make a proper decision for the driver, and in a current driving situation, irrespective of a driver's intention, the autonomous driving system may perform only a predetermined algorithm, thereby failing to reflect driving styles of individual drivers.

In addition, since the conventional autonomous driving system makes a driving decision using basic information about surrounding road objects, such as a position, a heading, and a speed, and classes (vehicle, pedestrian, and bicycle), recognition reliability may be lowered according to an environment during driving, and it is difficult to recognize various exceptional situations (construction, illegal parked/stopped vehicles, and low-speed vehicles). Thus, the conventional autonomous driving system has no choice but to conservatively determine an action such as stopping.

Conventional autonomous driving systems frequently fails to accurately determine road driving situations. When an autonomous driving system fails to accurately determine a road driving situation, if the time required to reach a destination increases or a vehicle is stopped indefinitely, with the driver of the vehicle not informed of the situation, there is a problem that the driver cannot trust the system.

### SUMMARY OF THE INVENTION

The present invention is directed to providing a metacognition-based autonomous driving correction device which operates in an autonomous driving system. The device queries a driver to determine a current driving situation when it recognizes ambiguity of determination in a specific driving situation (metacognition). Then, it self-determines a driving behavior according to the determined current driving situation or queries the driver for a driving behavior so as to allow driver-customized autonomous driving to be performed.

The present invention is also directed to providing a metacognition-based autonomous driving correction device which corrects, when a command is received from a driver even though an autonomous driving system does not inquire about a driving situation of the driver, a driving behavior when a driver's request is executable in a current driving situation, thereby efficiently performing autonomous driving to a destination.

Objects of the present invention are not limited to the above-described objects, and other objects that have not been described above will be apparent from the following description.

To solve the problems, according to one embodiment of the present invention, a metacognition-based autonomous driving correction device for an autonomous driving system includes a driving situation recognition/driving behavior-based determination unit which determines metacognition with respect to a front object recognized during autonomous driving using driving environment recognition information acquired through a vehicle sensor unit and corrects a global route or a local route so as to correspond to selection correction information selected after metacognition is determined, and a driving situation recognition/driving behavior correction terminal unit which outputs pieces of candidate correction information when a driving situation of the front object is determined to correspond to metacognition and then provides the selection correction information selected from among the pieces of output candidate correction information by a driver to the driving situation recognition/driving behavior-based determination unit.

The driving situation recognition/driving behavior-based determination unit may have a driving situation determination function of determining metacognition for determining the ambiguity of a current driving situation through driving situation recognition information.

The driving situation recognition/driving behavior correction-based determination unit may determine metacognition according to whether all pieces of information necessary for determining the metacognition of recognized object information are included.

The driving situation recognition/driving behavior correction-based determination unit may determine metacognition according to the number of selectable driving behaviors in a corresponding situation.

The driving situation recognition/driving behavior correction-based determination unit may determine that a state in which a driving situation is not specified corresponds to metacognition using object recognition information.

When a specific object moves at a speed that is lower than a current road speed by a specific threshold or less, the driving situation recognition/driving behavior correction-based determination unit may determine that a driving state of the specific object corresponds to metacognition.

The candidate correction information may be one of driving situation candidate correction information including driving situation information and driving behavior candidate correction information including pieces of driving behavior information.

The driving situation recognition/driving behavior correction terminal unit may include a driving situation output part configured to output driving situation recognition information with respect to a query object, and a driving situation selection part configured to output driving situation recognition candidate correction information selectable by the driver recognizing an output driving situation and configured to provide driving situation recognition selection correction information selected by the driver.

The driving situation recognition/driving behavior correction terminal unit may include a driving behavior selection part configured to output driving behavior candidate correction information selectable by the driver recognizing the output driving situation and configured to provide driving behavior selection correction information selected by the driver.

The metacognition-based autonomous driving correction device may further include a correction information sharing unit which transmits shared correction information transmitted to a server to a surrounding vehicle through a vehicle-to-vehicle (V2V) communicator which is a communication part and to an infrastructure through a vehicle-to-everything (V2X) communicator which is a communication part or transmits the shared correction information to the surrounding vehicle subscribed to a service through a telematics service or the like.

When the shared correction information is received from the surrounding vehicle, the infrastructure, and the server and the driving status is determined to correspond to metacognition, the correction information sharing unit may correct the global route or the local route using the shared correction information.

The shared correction information may have an information transmission fields including an encrypted object identification(ID) that corresponds to a license plate number for uniqueness, an image, an object bounding box, a recognition time, a position, a speed, and a driving situation semantic label.

One-way encrypting may be performed on the object ID so as to protect personal information of a target vehicle.

According to one embodiment of the present invention, a metacognition-based autonomous driving correction method includes recognizing, by a driving environment recognition unit, a front object from acquired recognition information, calculating, by the driving environment recognition unit, a road speed of a current driving road, determining, by the driving environment recognition unit, whether the front object is present, in the determining of whether the front object is present, when the front object is recognized, determining, by a driving situation recognition/driving behavior correction-based determination unit, whether a speed of the recognized front object is lower than the road speed, in the determining of whether the speed of the object is lower than the road speed, when the speed of the front object is lower than the road speed, determining, by the driving situation recognition/driving behavior correction-based determination unit, whether driving situation candidate correction information with respect to the recognized object is present, and in the determining of whether the driving situation candidate correction information with respect to the recognized object is present, when the correction information is not present, outputting, by the driving situation recognition/driving behavior correction-based determination unit, candidate correction information to a driving situation recognition/driving behavior correction terminal unit and correcting driving situation recognition.

The metacognition-based autonomous driving correction method of the present invention may include determining whether the recognized front object is a vehicle, in the determining of whether the front object is a vehicle, when the front object is a vehicle, determining whether a license plate of the front object is recognized, in the determining of whether the license plate of the front object is recognized, when the license plate of the front object is recognized, generating, by a correction information sharing unit, an encrypted object ID including the license plate of the front object, and generating, by the correction information sharing unit, correction information including the encrypted object ID and transmitting the generated correction information to a surrounding vehicle and an infrastructure through the correction information sharing unit.

The metacognition-based autonomous driving correction method may further include, a vehicle, when the front object is not a vehicle, determining whether the front object is in a stopped state, in the determining of whether the front object is in the stopped state, when the front object is in the stopped state, acquiring, by a correction information sharing unit, a global position and generating correction information, and transmitting, by the correction information sharing unit, the generated correction information to a surrounding vehicle and an infrastructure.

The metacognition-based autonomous driving correction method of the present invention may further include determining, by the driving situation recognition/driving behavior correction terminal unit, whether driving behavior correction has been automatically performed, in the determining of whether the driving behavior correction has been automatically performed, when the driving behavior correction has not been automatically performed, outputting, by the driving situation recognition/driving behavior correction-based determination unit, driving behavior candidate correction information including driving behavior information to the driving situation recognition/driving behavior correction terminal unit, determining whether the driver has selected driving behavior selection correction information, in the determining of whether the driver has selected the driving behavior selection correction information, when the driving behavior selection correction information is not input from the driver, determining, by the driving situation recognition/driving behavior correction based-determination unit, a driving behavior as a basic driving behavior, and when the selected driving behavior selection correction information is input from the driver, determining whether a distance to an intersection is sufficient, in the determining of whether the distance to an intersection is sufficient, when the distance to the intersection is not sufficient, determining, by the driving situation recognition/driving behavior correction-based determination unit, the driving behavior as the basic driving behavior, and when the distance to the intersection is sufficient, determining whether a global route needs to be re-searched for, in the determining of whether the global route needs to be re-searched for, when the global route does not need to be re-searched for, determining, by the driving situation recognition/driving behavior correction-based determination unit, whether the selected driving behavior selection correction information is applicable, and in the determining of whether the selected driving behavior selection correction information is applicable, when the selected driving behavior selection correction information is applicable, determining, by the driving situation recognition/driving behavior correction-based determination unit, the driving behavior using the selected driving behavior selection correction information.

The metacognition-based autonomous driving correction method may include, in the determining of whether the global route needs to be re-searched for, when the global route needs to be re-searched for, re-searching for, by the driving situation recognition/driving behavior correction-based determination unit, the global route.

According to one embodiment of the present invention, a driving behavior correction method in an autonomous driving system includes receiving shared correction information including an encrypted object ID from a surrounding vehicle and an infrastructure, determining whether a front object is a vehicle, in the determining of whether the front object is a vehicle, when the front object is a vehicle, recognizing a license plate of the front object, generating an encrypted object ID including the license plate of the front object, determining whether the encrypted object ID included in the received shared correction information matches the generated encrypted object ID, when the received encrypted object ID matches the generated encrypted object ID, determining, by a driving situation recognition/driving behavior correction-based determination unit, whether driving situation candidate correction information with respect to a recognized object is present, and in the determining of whether the driving situation candidate correction information with respect to the recognized object is present, when the driving situation candidate correction information with respect to the recognized object is not present, correcting, by the driving situation recognition/driving behavior correction-based determination unit, driving situation recognition using the shared correction information.

The driving behavior correction method may further include, in the determining of whether the front object is a vehicle, when the front object is not the vehicle, determining whether the front object is in a stopped state, in the determining of whether the front object is in a stopped state, when the front object is in the stopped state, acquiring a global position of the front object, determining whether a global position included in the received shared correction information matches the acquired global position of the front object, and in the determining of whether the global position information matches the acquired global position, when the global position included in the received shared correction information matches the acquired global position of the front object, determining, by the driving situation recognition/driving behavior correction-based determination unit, whether driving situation candidate correction information with respect to the recognized object is present.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a functional block diagram for describing a metacognition-based autonomous driving correction device according to one embodiment of the present invention;

FIG. 2 is a reference diagram for describing an example in which driving situation recognition is corrected by a driver in the metacognition-based autonomous driving correction device according to one embodiment of the present invention;

FIG. 3 is a reference diagram for describing one example in which driving situation correction is performed by a driving situation recognition/driving behavior correction terminal unit of FIG. 1;

FIG. 4 is a reference diagram for describing an embodiment by a correction information sharing unit of FIG. 1;

FIG. 5 is a reference diagram for describing one example in which driving behavior correction is performed by the driving situation recognition/driving behavior correction terminal unit of FIG. 1;

FIGS. 6A to 6C are flowcharts for describing a driving situation recognition method in a metacognition-based autonomous driving correction method according to one embodiment of the present invention;

FIG. 7 is a flowchart for describing a driving situation recognition method using shared information in a metacognition-based autonomous driving correction method according to one embodiment of the present invention; and

FIGS. 8A and 8B are flowcharts for describing driving behavior correction in a metacognition-based autonomous driving correction method according to one embodiment of the present invention.

### DETAILED DESCRIPTION OF EXEMPLARY EMBODIMENTS

The advantages and features of the present invention and methods for accomplishing the same will be more clearly understood from embodiments to be described in detail below with reference to the accompanying drawing. However, the present invention is not limited to the following embodiments but may be implemented in various different forms. Rather, these embodiments are provided only to complete the disclosure of the present invention and to allow those skilled in the art to understand the scope of the present invention. The present invention is defined by the scope of the claims. Meanwhile, terms used in this specification are to describe the embodiments and are not intended to limit the present invention. As used herein, singular expressions, unless defined otherwise in the context, include plural expressions. It will be further understood that the terms “comprises,” “comprising,” “includes,” and/or “including,” when used herein, specify the presence of stated components, steps, operations, and/or elements, but do not preclude the presence or addition of one or more other components, steps, operations, and/or elements.

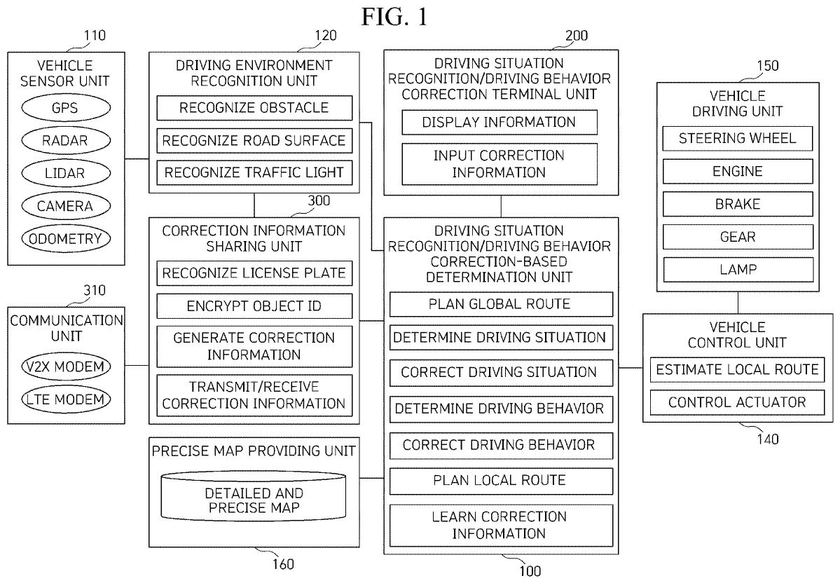

FIG. 1 is a functional block diagram for describing a metacognition-based autonomous driving correction device according to one embodiment of the present invention.

As shown in FIG. 1, the metacognition-based autonomous driving correction device according to one embodiment of the present invention includes a vehicle sensor unit 110, a driving environment recognition unit 120, a vehicle control unit 140, a vehicle driving unit 150, a driving situation recognition/driving behavior correction-based determination unit 100, a driving situation recognition/driving behavior correction terminal unit 200, and a correction information sharing unit 300.

The vehicle sensor unit 110 includes pieces of hardware such as a global positioning system (GPS), radar, a light detection and ranging (LiDAR) device, a camera, and an odometer which are used to obtain a position and a speed of an obstacle.

The driving environment recognition unit 120 provides functions of recognizing an obstacle, recognizing a road surface (lane), and recognizing a traffic light using the pieces of hardware of the vehicle sensor unit 110. The driving environment recognition unit 120 may further include a vehicle-to-everything (V2X) modem and a long term evolution (LTE) modem so as to exchange driving situation recognition information and driving behavior correction information.

The driving situation recognition/driving behavior correction-based determination unit 100 provides a function of planning a global route from a departure point to a destination using a precise map, a function of determining a driving situation using driving environment recognition information and the precise map, a function of determining a driving behavior, a function of planning a local route along which a vehicle can drive according to the determined driving behavior, and a function of correcting the driving situation and the driving behavior according to correction information.

The driving situation recognition/driving behavior correction-based determination unit 100 determines metacognition with respect to a front object o recognized during autonomous driving using position and speed information of a host vehicle 1 and the object acquired through the vehicle sensor unit 110. Metacognition in the present invention refers to a state in which the determination of a driving situation is ambiguous.

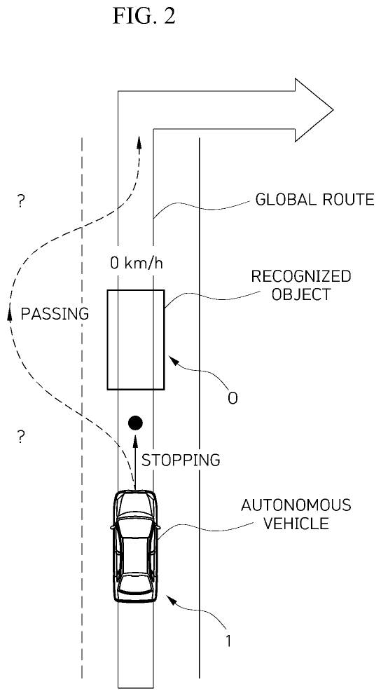

As an example, as shown in FIG. 2, the driving situation recognition/driving behavior correction-based determination unit 100 performs metacognition when a recognized object o in front of the host vehicle 1 is recognized during autonomous driving.

As shown in FIG. 2, a query object o (front vehicle) appears to be at a lower speed (for example, 0 km/h) that is significantly lower than a current road speed, but when an autonomous driving system cannot infer a driving situation of “accident” through an algorithm such as deep learning, the query object o is surrounded with a bounding box, and a driving situation currently determined by the system and a candidate driving situation (indicated by a dotted line in the present embodiment) are output on a screen to wait for a driver's decision. When a driver does not reply, a basic operation (i.e. ‘stop’) is maintained to wait until a specific critical time.

When a driving situation of the front object o is determined to correspond to metacognition, the driving situation recognition/driving behavior correction-based determination unit 100 receives and reflects correction information on a global route or a local route. Here, candidate correction information is one of driving situation selection information and driving behavior selection correction information.

The driving situation recognition/driving behavior correction-based determination unit 100 determines whether a current driving situation is recognizable, and when it is determined that the current driving situation is recognizable and there is only one selectable driving behavior in a corresponding situation, the driving situation recognition/driving behavior correction-based determination unit 100 performs driving along the original global route or local route.

On the other hand, when the current driving situation is determined to correspond to metacognition or there are a plurality of selectable driving behaviors, the driving situation recognition/driving behavior correction-based determination unit 100 receives driving situation selection information and driving behavior selection correction information from a driver, surrounding vehicles, or an infrastructure and performs correction to change the original global route or local route and perform driving along the changed route.

The driving situation recognition/driving behavior correction-based determination unit 100 performs metacognition through various methods. Among the methods, in a first method, all pieces of information necessary for determining metacognition using recognized object information are not included, and in a second method, it is difficult to specify a driving situation using object recognition information. In these methods, it can be determined that a current driving situation is ambiguous.

In another method, the driving situation recognition/driving behavior correction-based determination unit 100 may determine metacognition based on when a specific object moves at a speed that is lower than a current road speed (average speed of objects recognized within a recognition range) by a specific threshold or less.

As an example of another method for the driving situation recognition/driving behavior correction-based determination unit 100, as shown in [Equation 1], when one or more recognized surrounding objects are present, a current road speed V_{cu}r road is defined as an average speed of the surrounding objects.

Accordingly, the driving situation recognition/driving behavior correction-based determination unit 100 may determine metacognition when a speed V front object of the front object o is α (α<1) times less than the current road speed V_{cu}r road.

$${V}_{cur\_road} = ( {\sum }_{i = 1}^{n} {v}_{i} ) / n , \\ where n > 1 ( n \text{:} number of objects ) \\ if {v}_{front\_object} < α {V}_{cur\_road} then set flag\_need \_correction \qquad [ Equation 1 ]$$

Here, V_{cur_road} denotes a road speed, Vᵢ denotes a speed value of the surrounding object, and n denotes the number of recognized surrounding objects.

The vehicle control unit 140 includes a local route estimator 141 which estimates a local route and an actuator controller 142 which controls an actuator of the vehicle driving unit 150 according to the local route estimated by the local route estimator 141.

The vehicle driving unit 150 includes pieces of controllable vehicle hardware such as a steering wheel, an engine, a brake, a gear, and a lamp.

A precise map providing unit 160 stores a detailed and precise map of a road network at a lane level, which is information necessary for planning an entire route and a local route.

The driving situation recognition/driving behavior correction-based determination unit 100 may further include a function of learning driving situation determination and behavior determination in real time using correction information.

Meanwhile, the driving situation recognition/driving behavior correction terminal unit 200 provides a plurality of pieces of candidate correction information to a driver so as to request the driver to correct autonomous driving and provides selection correction information selected by the driver to the driving situation recognition/driving behavior correction-based determination unit 100.

The driving situation recognition/driving behavior correction terminal unit 200 obtains a precise map by querying the precise map providing unit 160, in which the detailed and precise map of the road network at a lane level is stored, and displays the obtained precise map to the user along with object information.

The driving situation recognition/driving behavior correction terminal unit 200 may be a device fixedly installed in a vehicle or a smart terminal carried by a driver or a passenger.

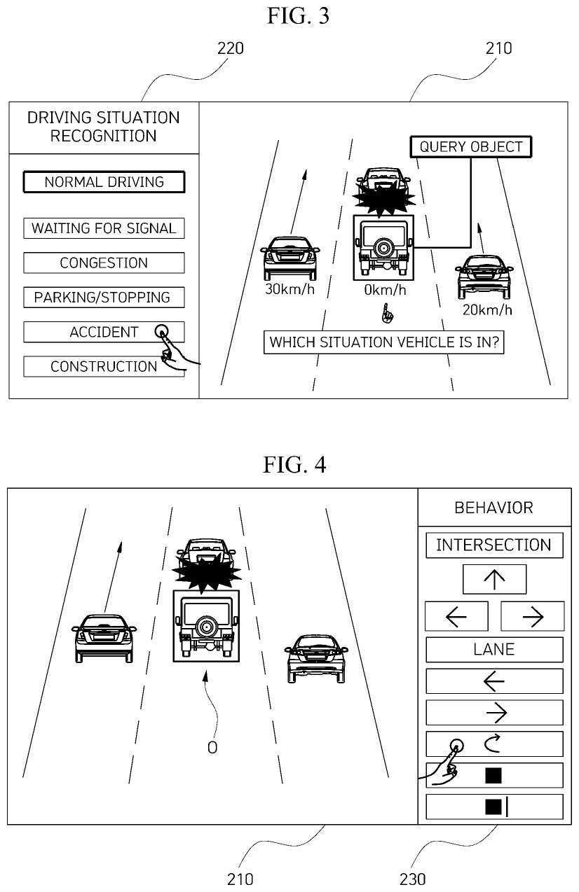

Meanwhile, as shown in FIG. 3, the driving situation recognition/driving behavior correction terminal unit 200 includes a driving situation output part 210 and a driving situation selection part 220.

A touch screen may be used for the driving situation recognition/driving behavior correction terminal unit 200, but the present invention is not limited thereto.

Here, driving situation recognition candidate correction information output from the driving situation selection part 220 may include information such as normal driving, waiting for a signal, congestion, parking/stopping, accident, and construction and further include other driving situation information.

The driving situation output part 210 outputs driving situation recognition information about the query object.

The driving situation selection part 220 outputs driving situation recognition candidate correction information such that a driver can select a driving situation and provides driving situation recognition selection correction information selected by the driver.

As an example, as shown in FIG. 3, the driving situation selection part 220 outputs driving situation recognition candidate correction information such as normal driving, waiting for a signal, congestion, parking/stopping, an accident, and construction, and when the driver selects a screen button of “accident” which is one piece of the driving situation recognition candidate correction information, the autonomous driving system sets a driving situation of the query object o to “accident.”

Thereafter, as shown in FIG. 4, according to a driving behavior determination method preset in the system, possible driving behavior candidate correction information is displayed to a driver to allow the driver to select overtaking or stopping or to automatically perform a set driving behavior (a behavior of following a front vehicle or stopping).

To this end, as shown in FIG. 4, the driving situation recognition/driving behavior correction terminal unit 200 outputs the driving behavior candidate correction information including driving behavior information through a screen such that the driver can select a driving behavior and provides driving behavior selection correction information selected by the driver to the driving situation recognition/driving behavior correction-based determination unit 100.

Here, the driving behavior candidate correction information refers to driving behavior correction that may be taken in a general lane and intersection by an autonomous vehicle. The driving behavior correction may be one of in-lane driving behavior correction and intersection driving behavior correction.

The in-lane driving behavior correction may include changing to a left/right lane, passing, stopping, and pulling onto the shoulder, and the intersection driving behavior correction may include straight driving and left/right turning.

In addition, an in-lane driving behavior may refer to re-searching for a global route when a distance to the nearest intersection is short or when two or more lanes are present between a changed lane and a global route due to a lane change.

Intersection behavior correction refers to correcting a behavior at the nearest intersection. In a case in which a turn is corrected to be different from that in the original global route, when it is determined that the correction is achievable, a global route is re-searched for, and when it is determined that the correction is impossible due to surrounding vehicles, the correction may be ignored.

Meanwhile, the correction information sharing unit 300 may transmit shared correction information transmitted to the server to the surrounding vehicles through a V2V modem of the communication unit 310, or to the infrastructure through a V2X modem of the communication unit 310. In addition, the correction information sharing unit 300 may transmit the shared correction information transmitted to the server to surrounding vehicles subscribed to a service through a telematics service using an LTE modem of the communication unit 310.

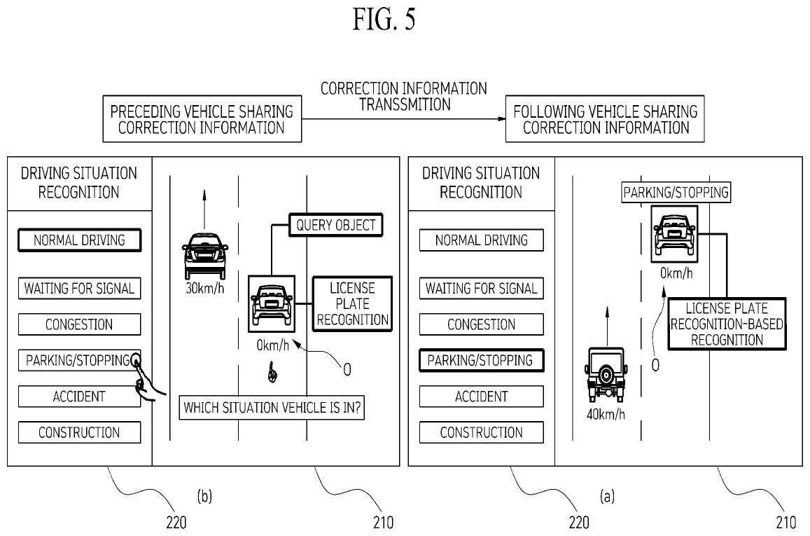

As shown in FIG. 5, when shared correction information is received from the surrounding vehicles, the infrastructure, and the server through the correction information sharing unit 300 and when a driving situation is determined to correspond to metacognition, the driving situation recognition/driving behavior correction-based determination unit 100 may use and reflect the received shared correction information on a global route or a local route.

Information transmission fields included in the shared correction information provided by the correction information sharing unit 300 includes an encrypted object ID, an image, an object Bounding Box, a recognition time, a position, a speed and a driving situation semantic label. After generating an object ID corresponding to a license plate number for the uniqueness of the object ID, an encrypted object ID is generated through one-way encryption of the object ID so as to protect personal information of a target vehicle.

Shared driving situation recognition correction data is learning data that is costly and time consuming because the frequency of collection is not high on general roads when it is collected by the existing method. However, in the case of collecting the shared driving situation recognition correction data according to the method presented in an embodiment of the present invention, separate collection costs are not required and additional editing is not required because the ground truth data is already included. Accordingly, the shared driving situation recognition correction data collection method according to the present invention is valuable because it does not require collection cost and editing cost.

In the present invention, shared driving situation recognition correction data can be stored in the host vehicle 1 and the server and used as learning data for deep learning.

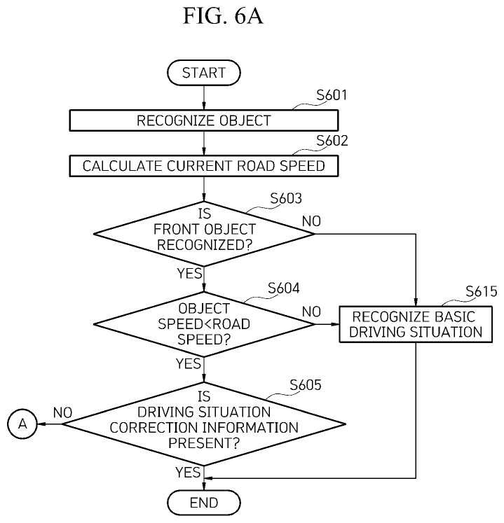

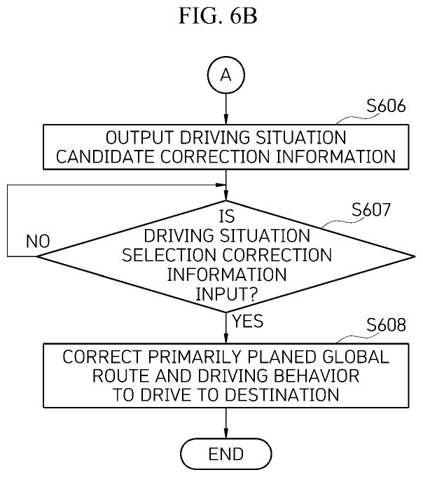

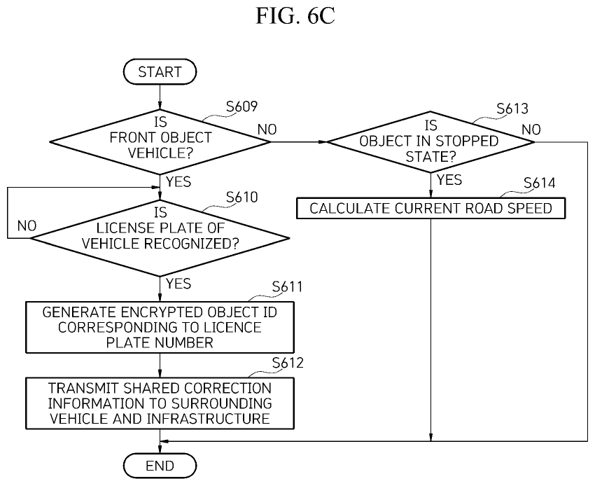

Hereinafter, a metacognition-based autonomous driving correction method according to one embodiment of the present invention will be described with reference to FIGS. 6A to 6C.

First, a driving environment recognition unit 120 recognizes a front object o from information acquired using a vehicle sensor unit 110 (S601).

Thereafter, the driving environment recognition unit 120 calculates a road speed of a current driving road (S602). That is, the driving environment recognition unit 120 may calculate a current road speed V_{cur_road} of current road network links around a host vehicle using speeds of recognized objects.

Next, the driving environment recognition unit 120 determines whether a front object is present through the vehicle sensor unit 110 (S603). Here, the object includes a vehicle and an obstacle.

In operation S603 of determining whether the front object is present, when the front object is recognized (YES), it is determined whether a speed of a recognized front object o is lower than the road speed (S604). In this case, it is checked whether the speed of the front object o is lower than a preset multiple a of the current road speed.

In operation S604 of determining whether the speed of the object is lower than the road speed, when the speed of the front object o is greater than or equal to the road speed (NO), the front object o is also in a driving situation so that basic driving situation recognition is set to not be corrected.

On the contrary, in operation S604 of determining whether the speed of the object is lower than the road speed, when the speed of the front object o is lower than the road speed (YES), it is determined whether driving situation candidate correction information with respect to the recognized object is present (S605). This is to check whether the driving situation candidate correction information with respect to the corresponding object is present.

In operation S605 of determining whether the driving situation candidate correction information with respect to the recognized object is present, when the driving situation candidate correction information is present (YES), then the procedure is ended because driving situation semantic information has been tagged to the object by a driver, surrounding vehicles or an infrastructure.

On the contrary, in operation S605 of determining whether the driving situation candidate correction information with respect to the recognized object is present, when the driving situation candidate correction information is not present (NO), the driving situation candidate correction information is output to a driving situation recognition/driving behavior correction terminal unit 200 (S606).

Thereafter, it is determined whether driving situation selection correction information selected by the driver is input (S607).

In operation S607 of determining whether the driving situation selection correction information is input, when the driving situation selection correction information is input (YES), a global route and a driving behavior which are primarily planned are corrected to drive to a destination (S608).

Subsequently, it is determined whether the recognized front object o is a vehicle (S609).

In operation S609 of determining whether the front object o is a vehicle, when the front object o is a vehicle (YES), it is determined whether a license plate of the front object o is recognized (S610).

Then, in operation S610 of determining whether the license plate of the front object o is recognized, when the license plate of the front object o is recognized (YES), after an encrypted object ID including the license plate of the front object o is generated (S611), correction information is generated and transmitted to the surrounding vehicles and the infrastructure through a correction information sharing unit 300 (S612).

On the other hand, in operation S609 of determining whether the front object o is a vehicle, when the front object o is not a vehicle (NO), it is determined whether the front object o is in a stopped state (S613).

In operation S613 of determining whether the front object o is in the stopped state, when the front object o is in the stopped state (YES), after a global position is acquired (S614) to generate correction information, the generated correction information is transmitted to the surrounding vehicles and the infrastructure through the correction information sharing unit 300 (S612).

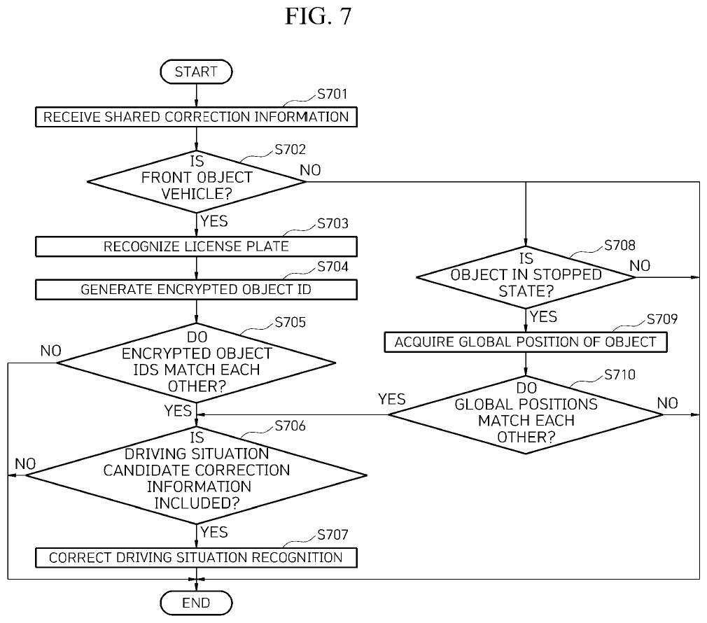

Hereinafter, a driving situation recognition correction method using received correction information in a metacognition-based autonomous driving correction method according to one embodiment of the present invention will be described with reference to FIG. 7.

First, shared correction information including an encrypted object ID is received through a V2X modem or an LTE modem from surrounding vehicles and an infrastructure (S701).

It is determined whether a front object o is a vehicle (S702).

In operation S702 of determining whether the front object o is a vehicle, when the front object o is a vehicle (YES), a license plate of the front object o is recognized (S703).

Thereafter, an encrypted object ID including the license plate of the front object o is generated (S704).

Next, as shown in FIG. 7, it is determined whether the encrypted object ID included in the received shared correction information matches the generated encrypted object ID (S705).

When the received encrypted object ID matches the generated encrypted object ID (YES), it is determined whether driving situation candidate correction information with respect to the recognized object is present in the shared correction information (S706).

In operation S706 of determining whether the driving situation candidate correction information with respect to the recognized object is present, when the driving situation candidate correction information is present (YES), driving situation recognition is corrected using the received shared correction information (S707).

In operation S702 of determining whether the front object o is a vehicle, when the front object o is not a vehicle (NO), it is determined whether the front object o is in a stopped state (S708).

In operation S708 of determining whether the front object o is in a stopped state, when the front object o is in the stopped state (YES), a global position of the front object o is acquired (S709).

Thereafter, it is determined whether a global position included in the received shared correction information matches the acquired global position of the front object o (S710).

In operation S710 of determining whether the global position matches the acquired global position, when the global position included in the received shared correction information matches the acquired global position of the front object o (YES), the procedure proceeds to operation S706 of determining whether the driving situation candidate correction information with respect to the recognized object is present.

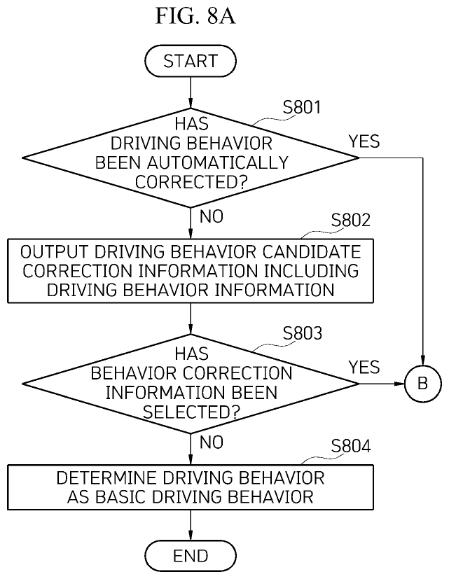

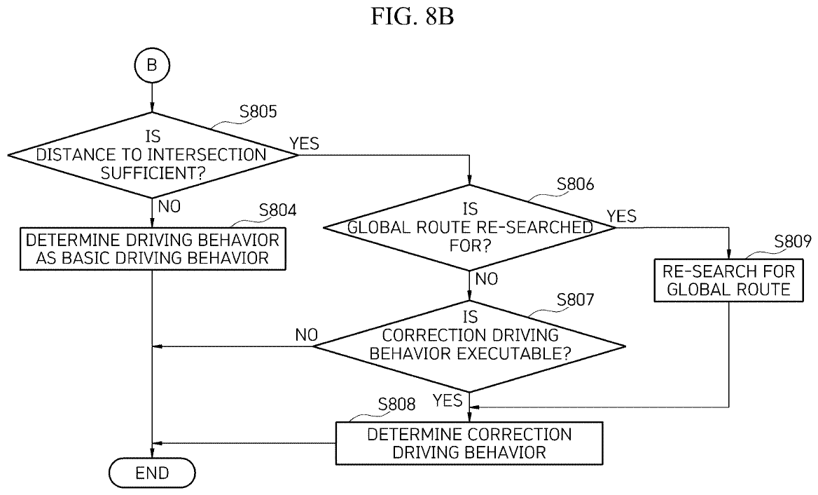

Hereinafter, a driving behavior correction method in a metacognition-based autonomous driving correction method according to one embodiment of the present invention will be described with reference to FIGS. 8A and 8B.

First, it is determined whether driving behavior correction has been automatically performed in a driving situation recognition/driving behavior correction terminal unit 200 (S801).

In operation S801 of determining whether the driving behavior correction has been automatically performed, when the driving behavior correction has not been automatically performed (NO), driving behavior candidate correction information including driving behavior information is output to the driving situation recognition/driving behavior correction terminal unit 200 (S802).

Thereafter, it is determined whether a driver has selected the output driving behavior information (S803).

In operation S803 of determining whether the driver has selected the driving behavior information, when driving behavior selection correction information is not input from the driver (NO), a driving behavior is determined as a basic driving behavior (S804).

On the contrary, in operation S803 of determining whether the driver has selected the driving behavior information, when the driving behavior selection correction information is selected by the driver (YES), it is determined whether a distance to an intersection is sufficient (S805).

In operation S805 of determining whether the distance to an intersection is sufficient, when the distance to the intersection is not sufficient (NO), a driving behavior is determined as the basic driving behavior, and when the distance to the intersection is sufficient (YES), it is determined whether a global route needs to be re-searched for (S806).

In operation S806 of determining whether the global route needs to be re-searched for, when the global route does not need to be re-searched for (NO), it is determined whether the selected driving behavior selection correction information is applicable (S807).

In operation S807 of determining whether the selected driving behavior selection correction information is applicable, when the selected driving behavior selection correction information is applicable (YES), a driving behavior is determined using the selected driving behavior selection correction information (S808).

In operation S806 of determining whether the global route needs to be re-searched for, when the global route needs to be re-searched for (YES), the global route is re-searched for (S809).

According to one embodiment of the present invention, an autonomous driving system can determine a current driving situation by recognizing whether it is possible to determine a specific driving situation to query a driver or receive correction information from surrounding vehicles and an infrastructure. In addition, the autonomous driving system can self-determine a driving behavior according to the determined current driving situation or can query the driver for a desired driving behavior again, thereby providing an effect capable of reducing a risk of indefinite stop due to failing to solve a specific driving situation or a misjudgment.

In addition, according to one embodiment of the present invention, even though an autonomous driving system does not inquire about a driving situation of a driver, when a command is received from the driver, the autonomous driving system corrects a driving behavior when a driver's request is acceptable in a current driving situation, thereby providing an advantage capable of performing customized autonomous driving reflecting a driver's intention.

According to one embodiment of the present invention, even though a driver does not input correction information, an autonomous driving system operates the same as an existing autonomous driving system, thereby providing effects of ensuring at least the same function and performance as the existing autonomous driving system and ensuring higher convenience and safety when drivers input additional information.

For reference, the components according to the embodiments of the present invention may be embodied by software or hardware such as a field programmable gate array (FPGA) or an application specific integrated circuit (ASIC) and may perform certain functions.

However, the components should be understood as not being limited to software or hardware, and each of the components may be included in an addressable storage medium or configured to reproduce one or more processors.

Therefore, as an example, the components include components such as software components, object-oriented software components, class components, and task components, processes, functions, attributes, procedures, subroutines, segments of program code, drivers, firmware, microcode, circuits, data, databases, data structures, tables, arrays, and variables.

The components and functions provided in the components may be combined into a smaller number of components or may be further divided into additional components.

Here, it can be understood that each block of the flowcharts and a combination of the flowcharts can be performed by computer program instructions Since the computer program instructions can be loaded into a processor of a general purpose computer, a special computer, or other programmable data processing equipment, instructions performed via a processor of a computer or other programmable data processing equipment generates means for performing functions described in block(s) of the flowcharts. Since the computer program instructions can be stored in a computer available or computer readable memory capable of configuring a computer or other programmable data processing equipment to implement functions in a specific scheme, instructions stored in the computer available or computer readable memory can produce manufacturing articles involving an instruction means executing functions described in block(s) of the flowcharts. Since the computer program instructions can be loaded onto a computer or other programmable data processing equipment, a series of operational steps are performed in the computer or other programmable data processing equipment to create a process executed by the computer or other programmable data processing equipment such that instructions performed by the computer or other programmable data processing equipment can provide steps for executing functions described in the block(s) of the flowcharts.

Furthermore, each block can indicate a part of a module, a segment, or code including at least one executable instruction for executing specific logical function(s). In addition, it should be noted that several alternative execution examples can generate functions described in blocks out of order. For example, two consecutive blocks can be simultaneously performed, and occasionally, the blocks may be performed in a reverse order according to corresponding functions.

Here, the term “˜ unit” used in the present embodiment refers to a software or hardware component, such as an FPGA or ASIC, which performs a predetermined function. However, the term “˜ unit” is not limited to the software or hardware component. A “˜ unit” may be configured to reside in an addressable storage medium and configured to operate one or more processors. Thus, a “˜ unit” may include, by way of example, components, such as software components, object-oriented software components, class components and task components, processes, functions, attributes, procedures, subroutines, segments of program code, drivers, firmware, microcode, circuitry, data, databases, database structures, tables, arrays, and parameters. The functionality provided in the components and “˜ units” may be combined into fewer components and units or further separated into additional components and “˜ units.” In addition, the components and “˜ units” may be implemented such that the components and units operate one or more central processing units (CPUs) in a device or a security multimedia card.

Although configurations of the present invention have been described in detail above with reference to the accompanying drawings, these are merely examples, and those of ordinary skill in the technical field to which the present invention pertains can make various modifications and changes within the technical spirit of the present invention. Therefore, the scope of the present invention should not be limited to the above-described embodiments but should be determined by the appended claims.

What is claimed is:

1. A metacognition-based autonomous driving correction device for an autonomous driving system, comprising:
a driving situation recognition/driving behavior-based determination unit which determines metacognition with respect to a front object recognized during autonomous driving using driving environment recognition information acquired through a vehicle sensor unit and corrects a global route or a local route so as to correspond to selection correction information selected after metacognition is determined; and
a driving situation recognition/driving behavior correction terminal unit which outputs pieces of candidate correction information when a driving situation of the front object is determined to correspond to the metacognition and then provides the selection correction information selected from among the pieces of output candidate correction information by a driver to the driving situation recognition/driving behavior-based determination unit.

2. The metacognition-based autonomous driving correction device of claim 1, wherein the driving situation recognition/driving behavior-based determination unit has a driving situation determination function of determining metacognition for determining ambiguity of a current driving situation through driving situation recognition information.

3. The metacognition-based autonomous driving correction device of claim 2, wherein the driving situation recognition/driving behavior correction-based determination unit determines metacognition according to whether all pieces of information necessary for determining the metacognition of recognized object information are included.

4. The metacognition-based autonomous driving correction device of claim 2, wherein the driving situation recognition/driving behavior correction-based determination unit determines metacognition according to the number of selectable driving behaviors in a corresponding situation.

5. The metacognition-based autonomous driving correction device of claim 2, wherein the driving situation recognition/driving behavior correction-based determination unit determines that a state in which a driving situation is not specified corresponds to metacognition using object recognition information.

6. The metacognition-based autonomous driving correction device of claim 2, wherein, when a specific object moves at a speed that is lower than a current road speed by a specific threshold or less, the driving situation recognition/driving behavior correction-based determination unit determines that a driving state of the specific object corresponds to metacognition.

7. The metacognition-based autonomous driving correction device of claim 1, wherein the candidate correction information is one of driving situation candidate correction information including driving situation information and driving behavior candidate correction information including pieces of driving behavior information.

8. The metacognition-based autonomous driving correction device of claim 1, wherein the driving situation recognition/driving behavior correction terminal unit includes:
a driving situation output part configured to output driving situation recognition information with respect to a query object; and
a driving situation selection part configured to output driving situation recognition candidate correction information selectable by the driver recognizing an output driving situation and configured to provide driving situation recognition selection correction information selected by the driver.

9. The metacognition-based autonomous driving correction device of claim 8, wherein the driving situation recognition/driving behavior correction terminal unit includes a driving behavior selection part configured to output driving behavior candidate correction information selectable by the driver recognizing the output driving situation and configured to provide driving behavior selection correction information selected by the driver.

10. The metacognition-based autonomous driving correction device of claim 1, further comprising a correction information sharing unit which transmits shared correction information transmitted to a server to a surrounding vehicle through a vehicle-to-vehicle (V2V) communicator which is a communication part and to an infrastructure through a vehicle-to-everything (V2X) communicator which is a communication part or transmits the shared correction information to the surrounding vehicle subscribed to a service through a telematics service or the like.

11. The metacognition-based autonomous driving correction device of claim 10, wherein, when the shared correction information is received from the surrounding vehicle, the infrastructure, and the server and the driving status is determined to correspond to metacognition, the correction information sharing unit corrects the global route or the local route using the shared correction information.

12. The metacognition-based autonomous driving correction device of claim 11, wherein the shared correction information has information transmission fields including an encrypted object identification(ID) that corresponds to a license plate number for uniqueness, an image, an object bounding box, a recognition time, a position, a speed, and a driving situation semantic label.

13. The metacognition-based autonomous driving correction device of claim 12, wherein one-way encrypting is performed on the object ID so as to protect personal information of a target vehicle.

14. A metacognition-based autonomous driving correction method comprising:
recognizing, by a driving environment recognition unit, a front object from acquired recognition information;
calculating, by the driving environment recognition unit, a road speed of a current driving road;
determining, by the driving environment recognition unit, whether the front object is present;
in the determining of whether the front object is present, when the front object is recognized, determining, by a driving situation recognition/driving behavior correction-based determination unit, whether a speed of the recognized front object is lower than the road speed;
in the determining of whether the speed of the object is lower than the road speed, when the speed of the front object is lower than the road speed, determining, by the driving situation recognition/driving behavior correction-based determination unit, whether driving situation candidate correction information with respect to the recognized object is present; and
in the determining of whether the driving situation candidate correction information with respect to the recognized object is present, when the correction information is not present, outputting, by the driving situation recognition/driving behavior correction-based determination unit, candidate correction information to a driving situation recognition/driving behavior correction terminal unit and correcting driving situation recognition.

15. The metacognition-based autonomous driving correction method of claim 14, comprising:
determining whether the recognized front object is a vehicle;
in the determining of whether the front object is a vehicle, when the front object is a vehicle, determining whether a license plate of the front object is recognized;
in the determining of whether the license plate of the front object is recognized, when the license plate of the front object is recognized, generating, by a correction information sharing unit, an encrypted object IDentification (ID) including the license plate of the front object; and
generating, by the correction information sharing unit, correction information including the encrypted object ID and transmitting the generated correction information to a surrounding vehicle and an infrastructure through the correction information sharing unit.

16. The metacognition-based autonomous driving correction method of claim 14, further comprising:
in the determining of whether the front object is a vehicle, when the front object is not a vehicle, determining whether the front object is in a stopped state;
in the determining of whether the front object is in a stopped state, when the front object is in the stopped state, acquiring, by a correction information sharing unit, a global position and generating correction information; and
transmitting, by the correction information sharing unit, the generated correction information to a surrounding vehicle and an infrastructure.

17. The metacognition-based autonomous driving correction method of claim 14, further comprising:
determining, by the driving situation recognition/driving behavior correction terminal unit, whether driving behavior correction has been automatically performed;
in the determining of whether the driving behavior correction has been automatically performed, when the driving behavior correction has not been automatically performed, outputting, by the driving situation recognition/driving behavior correction-based determination unit, driving behavior candidate correction information including driving behavior information to the driving situation recognition/driving behavior correction terminal unit;
determining whether the driver has selected driving behavior selection correction information;
in the determining of whether the driver has selected the driving behavior selection correction information, when the driving behavior selection correction information is not input from the driver, determining, by the driving situation recognition/driving behavior correction based-determination unit, a driving behavior as a basic driving behavior, and when the selected driving behavior selection correction information is input from the driver, determining whether a distance to an intersection is sufficient;
in the determining of whether the distance to an intersection is sufficient, when the distance to the intersection is not sufficient, determining, by the driving situation recognition/driving behavior correction-based determination unit, the driving behavior as the basic driving behavior, and when the distance to the intersection is sufficient, determining whether a global route needs to be re-searched for;
in the determining of whether the global route needs to be re-searched for, when the global route does not need to be re-searched for, determining, by the driving situation recognition/driving behavior correction-based determination unit, whether the selected driving behavior selection correction information is applicable; and
in the determining of whether the selected driving behavior selection correction information is applicable, when the selected driving behavior selection correction information is applicable, determining, by the driving situation recognition/driving behavior correction-based determination unit, the driving behavior using the selected driving behavior selection correction information.

18. The metacognition-based autonomous driving correction method of claim 17, comprising, in the determining of whether the global route needs to be re-searched for, when the global route needs to be re-searched for, re-searching for, by the driving situation recognition/driving behavior correction-based determination unit, the global route.

19. A metacognition-based autonomous driving correction method which includes a driving behavior correction method in an autonomous driving system, the metacognition-based autonomous driving correction method comprising:
receiving shared correction information including an encrypted object IDentification (ID) from a surrounding vehicle and an infrastructure;
determining whether a front object is a vehicle;
in the determining of whether the front object is a vehicle, when the front object is a vehicle, recognizing a license plate of the front object;
generating an encrypted object ID including the license plate of the front object;
determining whether the encrypted object ID included in the received shared correction information matches the generated encrypted object ID;
when the received encrypted object ID matches the generated encrypted object ID, determining, by a driving situation recognition/driving behavior correction-based determination unit, whether driving situation candidate correction information with respect to a recognized object is present; and
in the determining of whether the driving situation candidate correction information with respect to the recognized object is present, when the driving situation candidate correction information with respect to the recognized object is not present, correcting, by the driving situation recognition/driving behavior correction-based determination unit, driving situation recognition using the shared correction information.

20. The metacognition-based autonomous driving correction method of claim 19, further comprising:
in the determining of whether the front object is a vehicle, when the front object is not a vehicle, determining whether the front object is in a stopped state;
in the determining of whether the front object is in a stopped state, when the front object is in the stopped state, acquiring a global position of the front object;
determining whether a global position included in the received shared correction information matches the acquired global position of the front object; and
in the determining of whether the global position information matches the acquired global position, when the global position included in the received shared correction information matches the acquired global position of the front object, determining, by the driving situation recognition/driving behavior correction-based determination unit, whether driving situation candidate correction information with respect to the recognized object is present.
